(19) United States
(12) Patent Application Publication
(10) Pub. No.: US 2012/0000992 A1
(43) Pub. Date: Jan. 5, 2012

(54) PAINT CUP STRUCTURE OF PAINTBALL GUN

(76) Inventor: Hsien-Chao SHIH, Fahsing Hsien (TW)

(21) Appl. No.: 12/828,412

(22) Filed: Jul. 1, 2010

(51) Int. Cl. B05B 9/03

(52) U.S. Cl. 239/302

(57) ABSTRACT

An improved paint cup structure of a paintball gun designed according to the assembling of a paint cup and a paint connector of the paintball gun comprises a pair of paint cup embedding guide ribs with a guide inclination and installed at the exterior of an outlet pipe at a lower end of the paint cup, a pair of guide slots corresponding to the embedding guide ribs and formed from the top of an internal wall of the paint connector, and a pair of embedding latch slots with a guide inclination and extended laterally from the bottom of the guide slot, such that the paint cup can be mounted or removed, and the embedding guide ribs of the paint cup together with the guide slots of the paint connector and an embedding latch slot to obtain a quick and convenient assembling or disassembling and maintain a good positioning effect.

### BACKGROUND OF THE INVENTION

1. Field of the Invention

The present invention relates to an improved paint cup structure of a paintball gun to overcome the existing problems and shortcomings of the traditional way of securing a paint bottle with a paint connector of the paintball gun through screw connections, and the structural design of the invention allows the paint cup to be installed and combined with the paint connector of the paintball gun by a simple turning operation, so that the paint cup can be installed or removed quickly.

2. Description of the Related Art

With reference to FIGS. 1 and 2 for a paint cup 20 installed onto a paintball gun 10, a paint connector 11 is installed at a predetermined position at the top of a bore of the paintball gun 10, and an external thread 12 is formed at the internal periphery of the paint connector 11 and provided for securing an internal thread 22 formed on the external periphery of an outlet pipe 21 at a lower end of the paint cup 20, and a detachable cup cover 23 is installed at the top of the paint cup 20, and an air valve hole 24 is formed at the top of the cup cover 23, and a cover plug 25 is installed into the air valve hole 24 and an air inlet 26 is formed on a lateral side of the cover plug 25 for guiding in external air, such that if a trigger 13 of the paintball gun 10 is pressed, an air convection is produced to guide the paint contained in the paint cup 20 into the paintball gun 10 through the outlet pipe 21 and the paint connector 11, and then spray the paint out from a paint nozzle 14 installed at a gun mouth position to achieve an expected spraying effect.

However, the installation of the paint cup 20 onto the paintball gun 10 adopts internal and external threads for the connection. If it is necessary to install the paint cup 20 to the paint connector 11 of the paintball gun 10 again, users have to turn the paint cup 20 repeatedly and take much time before the users can secure the paint cup 20 to the paint connector 11 successfully. If it is necessary to remove the paint cup 20 from the paint connector 11, the users have to go through the repeated turning process and take much time before the paint cup 20 can be removed successfully. Obviously, such arrangement is tremendously troublesome, inconvenient and time-consuming. Before the paint cup 20 is installed or removed for each paint spray operation, the users have to go through both installation and removal, and such design is definitely not a good design and requires improvements.

### SUMMARY OF THE INVENTION

In view of the foregoing drawbacks of the conventional way of securing the paint cup of the paintball gun through screw threads, the inventor of the present invention based on years of experience in the related industry to conduct expensive researches and experiments, and finally developed an improved paint cup structure, in hope of simplifying the installation or removal of the paint cup by turning the paint cup to combine the paint cup with the paintball gun quickly and conveniently, so as to reduce the manufacturing time, and enhance the operation efficiency effectively.

Another objective of the present invention is to provide a structural design for simplify the operation of installing or removing the paint cup to or from the paintball gun, while maintaining the secured installation.

To achieve the aforementioned objective, the present invention provides an improved paint cup structure comprising a pair of paint cup embedding guide ribs with a guide inclination and installed at the exterior of an outlet pipe at a lower end of the paint cup, a pair of guide slots corresponding to the embedding guide ribs and formed from the top of an internal wall of the paint connector, and a pair of embedding latch slots with a guide inclination and extended laterally from the bottom of the guide slot, such that the paint cup can be mounted or removed, and the embedding guide ribs of the paint cup together with the guide slots of the paint connector and an embedding latch slot to obtain a quick and convenient assembling or disassembling and maintain a good positioning effect.

Therefore, it simply requires users to insert the embedding guide ribs of the outlet pipe into the guide slot of the corresponding paint connector, and turning the paint cup accordingly, such that the embedding guide ribs are rotated laterally to latch with the embedding latch slot of the paint connector for a quick installation of the paint cup, and the paint cup can be removed quickly by reversing the aforementioned process, and the invention can overcome the drawbacks of the inconvenient and time-consuming conventional way of connecting the paint cup through screw threads.

### BRIEF DESCRIPTION OF THE DRAWINGS

FIG. 1 is a schematic view of a structure of a conventional paint cup mounted onto a paintball gun;

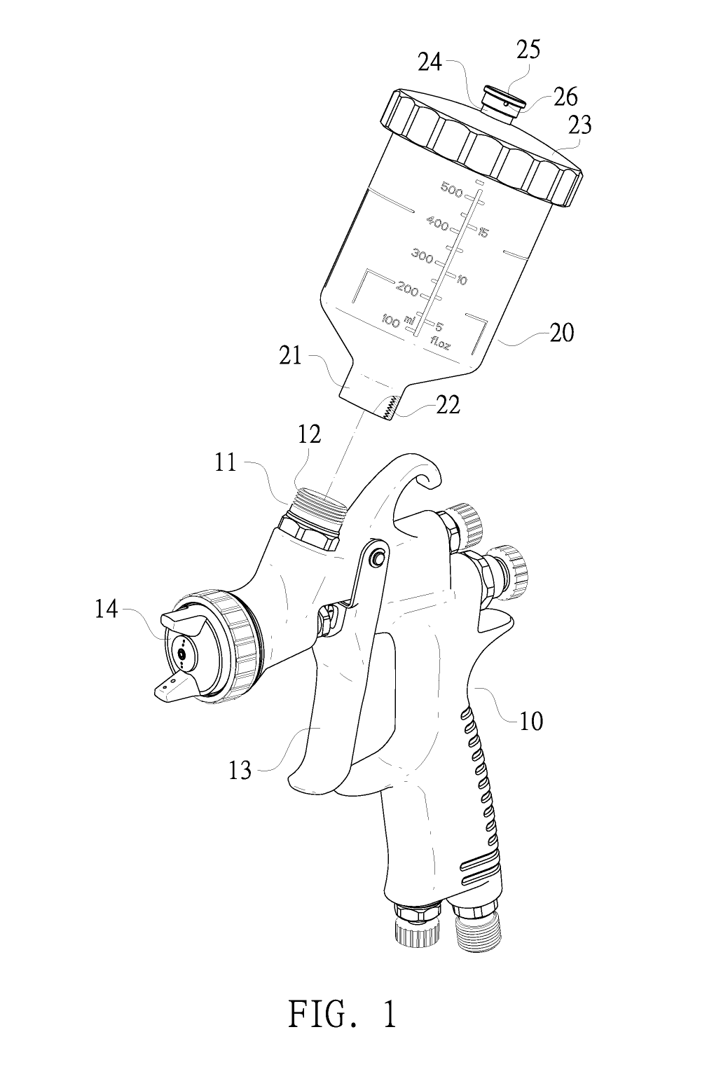

FIG. 2 is a schematic view, showing a structural relation of a conventional paint cup mounted onto a paintball gun;

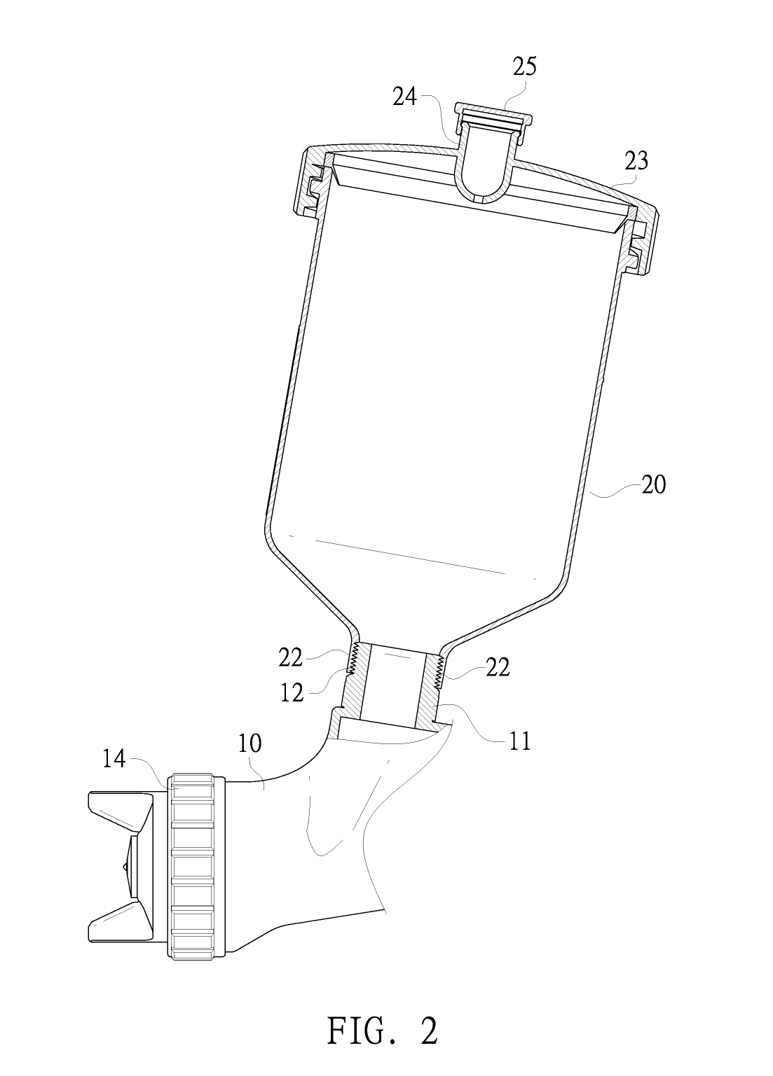

FIG. 3 is a schematic view of a structure in accordance with a preferred embodiment of the present invention;

FIG. 4 is an exploded view of a structure in accordance with a preferred embodiment of the present invention;

FIG. 5 is a schematic view, showing a structural relation before a paint cup is inserted into a paint connector in accordance with a preferred embodiment of the present invention;

FIG. 6 is a schematic view, showing a structural relation after a paint cup is inserted into a paint connector in accordance with a preferred embodiment of the present invention; and

FIG. 7 is a schematic view of rotating and securing a paint cup onto a paint connector in accordance with a preferred embodiment of the present invention.

### DETAILED DESCRIPTION OF THE PREFERRED EMBODIMENTS

The structural assembly, technical characteristic and effects of the present invention will become apparent with the detailed description of preferred embodiments and the illustration of related drawings.

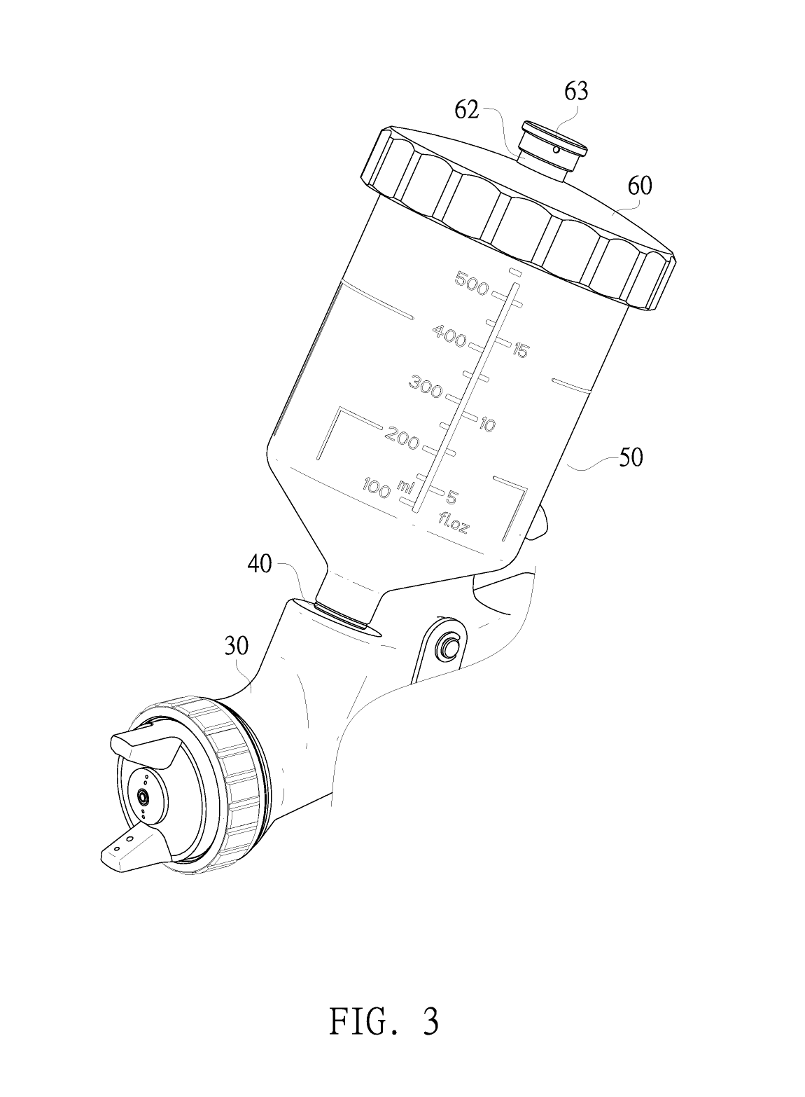

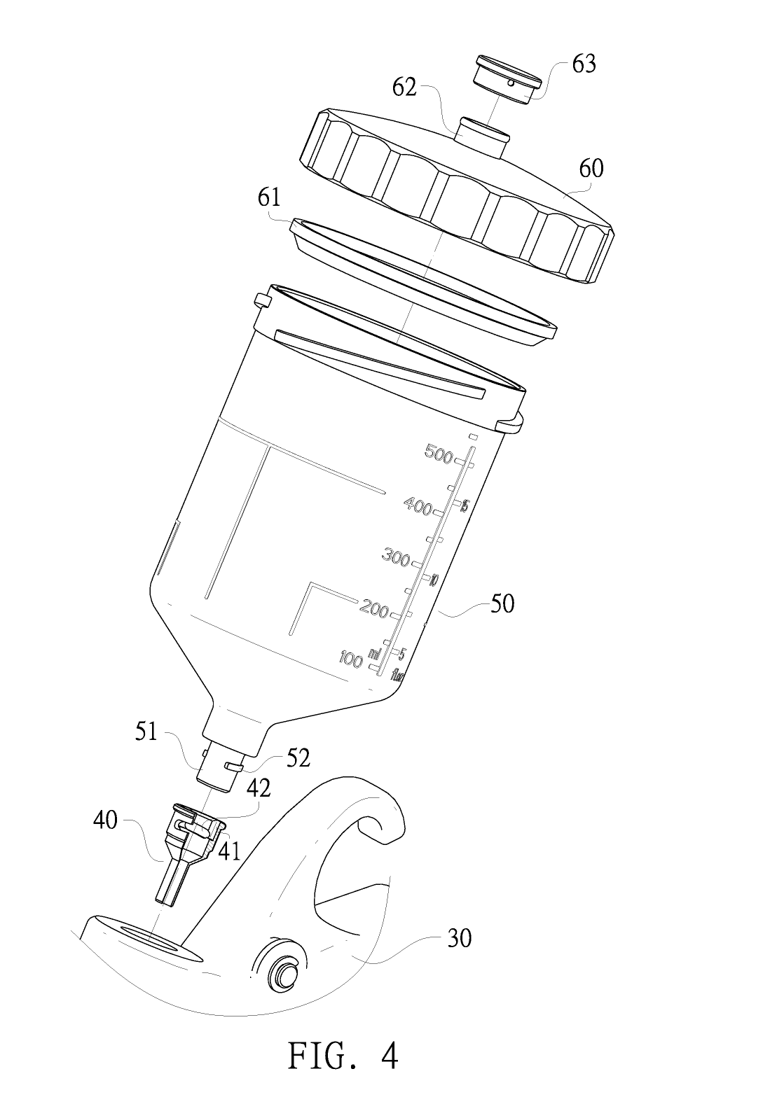

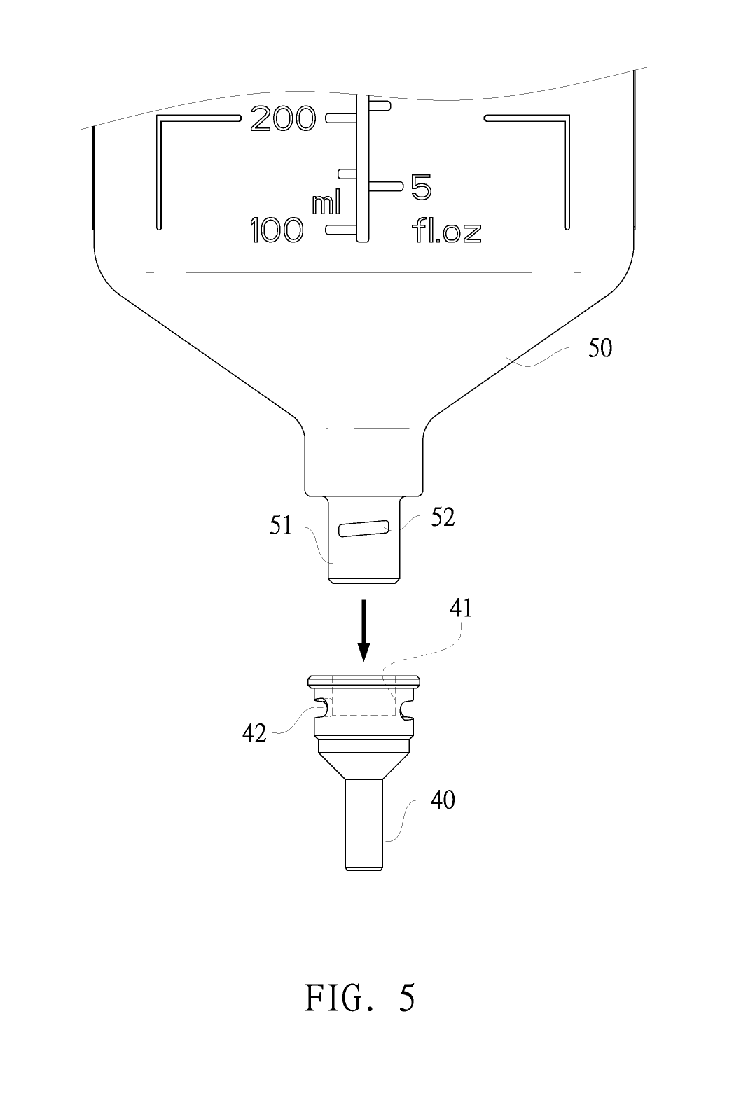

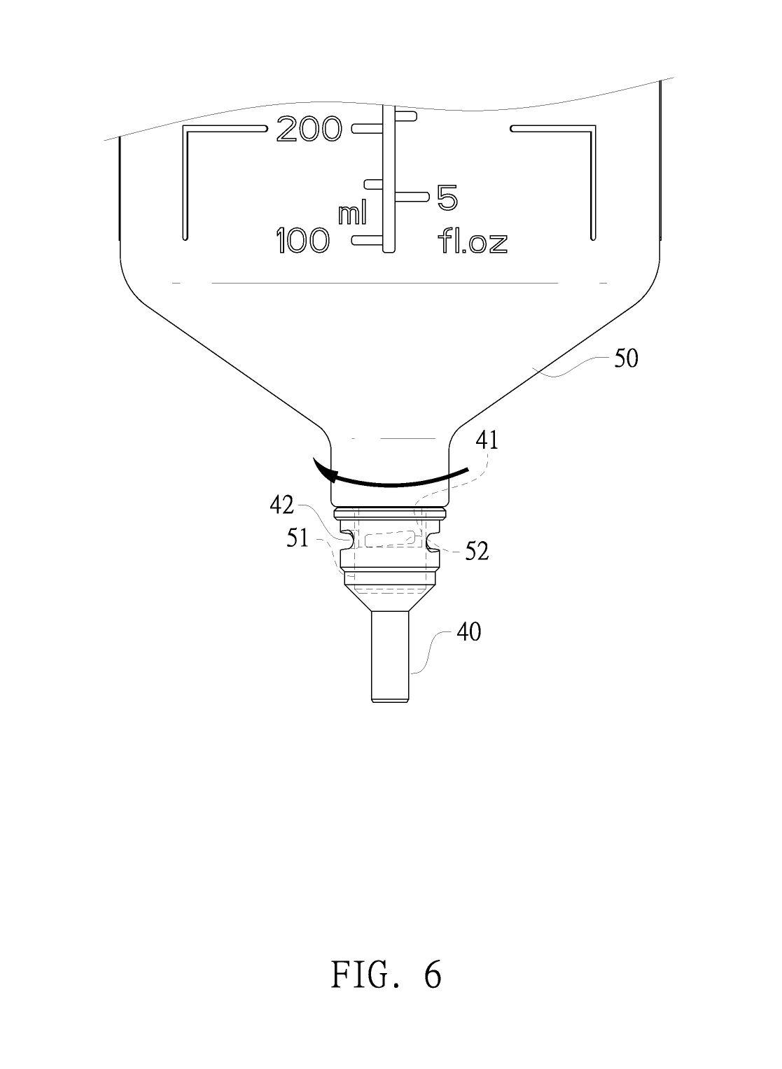

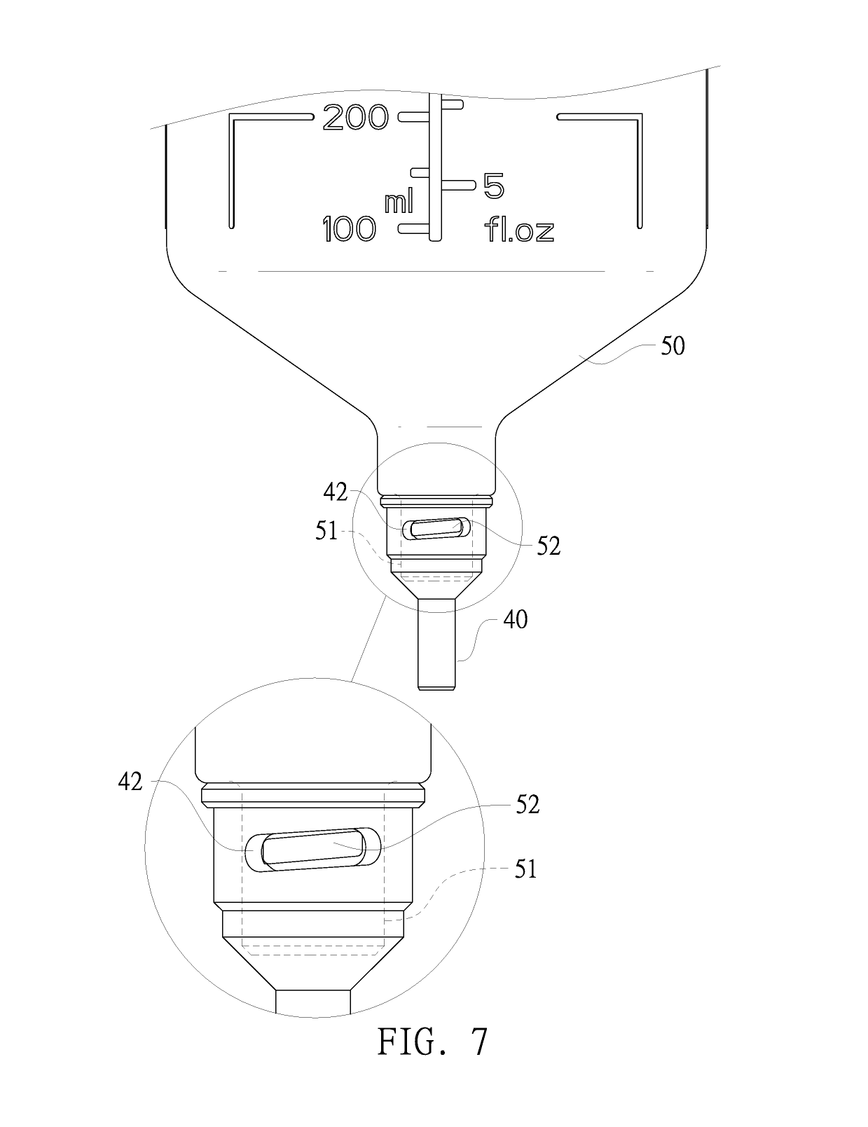

With reference to FIG. 3 for a schematic view of a structure, FIG. 4 for an exploded view of the structure, and FIGS. 5 to 7 for schematic views of a structural relation in accordance with a preferred embodiment of the present invention respectively, the structure comprises a paint connector 40 installed at a bore position of a paintball gun 30 and provided for installing a paint cup 50, a detachable cup cover 60 installed to the top of the paint cup 50, a compression ring 61 for securing the cup cover 60 and the paint cup 50 tightly, an air valve hole 62 formed at the top of the cup cover 60, and a cover plug 63 plugged into the air value hole 62 to constitute a basic functional architecture of the paintball gun 30 of the present invention to perform a paint spray operation.

The paint cup 50 includes a pair of embedding guide ribs 52 formed at the exterior of a base at a lower end of the outlet pipe 51, and the pair of embedding guide ribs 52 come with a predetermined guide inclination, and a pair of guide slots 41 are formed from the top edge at the internal periphery of the paint connector 40 and have a size corresponding to the length of the embedding guide ribs 52, and the guide slot 41 has a depth equal to the distance from the bottom edge of the embedding guide rib 52 to the bottom edge of the base of the paint cup 50, and a pair of embedding latch slots 42 are extended laterally from the bottom of the guide slot 41, and the embedding latch slots 42 are hollow or solid. In the meantime, the guide inclination of the pair of embedding latch slots 42 matches exactly with the embedding guide ribs 52. With such structural design, it simply requires to align the embedding guide ribs 52 of the outlet pipe 51 of the paint cup 50 with the guide slots 41 of the paint connector 40 for assembling the paint cup 50 with the paint connector 40 of the paintball gun 30, and after the outlet pipe 51 of the paint cup 50 is inserted into the paint connector 40, the paint cup 50 is turned accordingly to rotate the embedding guide rib 52 of the outlet pipe 51 in a lateral direction to latch the embedding latch slot 42 of the paint connector 40 into a fixed position, so as to complete assembling the paint cup 50 with the paintball gun 30 quickly. Since the embedding guide rib 52 and the embedding latch slot 42 have the same guide inclination to achieve a secured latching effect while effectively maintaining the connecting relation between the paint cup 50 and the paintball gun 30. If the paint cup 50 is rotated in an opposite direction, the paint cup 50 can be removed quickly, so as to overcome the trouble, inconvenience and time-consuming issues.

From the description above, the present invention no longer adopts the complicated screw threads for securing the paint cup with the paint connector of the paintball gun anymore, but simply uses the embedding guide rib of the outlet pipe at the lower end of the paint cup together with the guide slot and the embedding latch slot of the paint connector for a simple and easy turning movement to complete the installation or removal of the paint cup with respect to the paintball gun, while maintaining a very secured positioning effect. The present invention also achieves the same effect for a convenient and simple removal of the paint cup, such that users can save much time for the operation of installing or removing the paint cup. The invention not only improves the convenience of the application, but also improves the operation efficiency.

In summation of the above description, the present invention is designed according to the assembling of the paint connector and the paint cup of the paintball gun to simplify the assembling or disassembling procedure of the paint cup by providing a simple, easy and quick way by turning the paint cup to overcome the existing problems of the installation through the screw threads. Overall speaking, the present invention improves the performance over the conventional structure and further complies with the patent application requirements and thus is duly submitted for patent application.

While the invention has been described by means of specific embodiments, numerous modifications and variations such as a change of numeric values or a replacement of an equivalent component could be made thereto by those skilled in the art without departing from the scope and spirit of the invention set forth in the claims.

What is claimed is:

1. An improved paint cup structure of a paintball gun, comprising a pre-made paint connector installed at a predetermined position of a bore of the paintball gun, and provided for connecting an outlet pipe at a lower end of a paint cup to constitute a paint spray operating function architecture of the paintball gun, characterized in that a pair of embedding guide ribs are form at the external edge of the outlet pipe at a lower end of a base of the paint cup, and a pair of guide slots formed at the internal periphery of the paint connector, and provided for sheathing the embedding guide ribs into the guide slots respectively, and an embedding latch slot formed laterally at a lower end of the guide slot and provided for rotatably turning the embedding guide rib into the embedding latch slot, such that the paint cup can be installed or removed by a simple turning operation.

2. The improved paint cup structure of a paintball gun as recited in claim 1, wherein the embedding guide rib of the outlet pipe at the lower end of the paint cup and the embedding latch slot at the internal periphery of the paint connector have predetermined guide inclinations respectively, and the guide inclinations are the same.

3. The improved paint cup structure of a paintball gun as recited in claim 1, wherein the paint connector has a width equal to the length of the embedding guide rib of the outlet pipe at a lower end of the paint cup.

4. The improved paint cup structure of a paintball gun as recited in claim 1, wherein the paint connector has a depth equal to the distance from a lower edge of the embedding guide rib to a bottom edge of a base of the paint cup.

5. The improved paint cup structure of a paintball gun as recited in claim 1, wherein the embedding latch slot of the paint connector comes with a hollow design.

6. The improved paint cup structure of a paintball gun as recited in claim 1, wherein the embedding latch slot of the paint connector comes with a solid design.
